(19) United States
(12) Patent Application Publication
(10) Pub. No.: US 2018/0336538 A1
(43) Pub. Date: Nov. 22, 2018

(54) SYSTEM FOR PROCESSING DEPOSIT OF RESOURCES WITH A RESOURCE MANAGEMENT SYSTEM

(71) Applicant: Bank of America Corporation, Charlotte, NC (US)

(72) Inventors: Kerry Michelle Cantley, Fort Mill, SC (US); David Joseph Koval, Charlotte, NC (US); Keith Dion Owes, Bordentown, NJ (US); Brett C. Carter, Huntersville, NC (US); James Wayland Pierce, JR., Cornelius, NC (US); Kim Leah Bunn, Saint Johns, FL (US); Sherri Sullivan, Newark, DE (US); Matthew Joseph Wallace, Media, PA (US); Veronica Smith, The Colony, TX (US)

(21) Appl. No.: 15/598,589

(22) Filed: May 18, 2017

(51) Int. Cl. G06Q 20/10; G06Q 20/40; G06Q 20/32; G06Q 20/02

(52) U.S. Cl. CPC G06Q 20/108; G06Q 20/027; G06Q 20/325; G06Q 20/40

(57) ABSTRACT

A system for processing tangible resources comprises a network communication interface and a memory device storing a resource deposit application. A processing device is operatively coupled to the memory device to execute computer-readable program code to: receive a request to process a tangible resource from a user; receive an image including identifiable information of the tangible resource; determine the validity of the request; and, upon determination that the request is valid, process the tangible resource without having physical custody of the tangible resource. The system also may include a user device including a network communication interface and a memory device storing a resource processing application. A processing device is operatively coupled to the memory device to execute computer-readable program code to: log into the tangible resource transfer processing system; transmit the request to process a tangible resource to a system; and transmit the image.

### BACKGROUND

Systems for providing on-line and/or mobile exchanges are known where a user may engage in a wide variety of different types of exchanges with parties with which the user has a relationship, such as with large institutions. The on-line and/or mobile exchanges are typically instituted via applications that are accessed from a user device that is in communication with the systems over a network. The user may also engage in a wide variety of face-to-face or physical exchanges with the same entity systems. The physical exchanges and on-line/mobile exchanges may at least partially include the same types of exchanges.

### BRIEF SUMMARY

In some embodiments a system for processing a tangible resource comprises a network communication interface and a memory device storing a tangible resource transfer processing application. A processing device is operatively coupled to the memory device. The processing device is configured to execute computer-readable program code to: receive a request to process a tangible resource from a user; receive an image including identifiable information of the tangible resource; determine the validity of the request; upon determination that the request is valid, process the tangible resource without having physical custody of the tangible resource.

In some embodiments a method for processing a tangible resource comprises: receiving a request to process of a tangible resource from a user; receiving an image including identifiable information of the tangible resource; determining the validity of the request; upon determining that the request is valid, processing the tangible resource without having physical custody of the tangible resource.

In some embodiments a system for processing a tangible resource comprises a network communication interface and a memory device storing a tangible resource transfer processing application. A processing device is operatively coupled to the memory device. The processing device is configured to execute computer-readable program code to: log into a tangible resource transfer processing system; transmit a request to process a tangible resource to a system; and transmit an image including identifiable information of the tangible resource.

The tangible resource may comprise cash. The identifiable information may comprise a serial number of the cash. The image may comprise an image of the cash. The process may comprise a deposit of the cash with a financial institution. The instructions may be received from at least one of a mobile device and a personal computing device. The physical custody of the tangible resource may be received after the transaction is processed. The validity of the request may be determined using input from a resource tracking system. The validity of the request may be determined using the status of the user. A confirmation may be transmitted to the user after completion of the processing of the request.

### BRIEF DESCRIPTION OF THE DRAWINGS

FIG. 1 is a block diagram illustrating a system for processing the transfer of tangible resources, in accordance with embodiments of the invention.

FIG. 1A is a block diagram illustrating a system for tracking tangible resources, in accordance with embodiments of the invention.

FIG. 2 is a block diagram illustrating the mobile device of FIG. 1, in accordance with embodiments of the invention.

FIG. 3 is a block diagram illustrating the personal computing device of FIG. 1, in accordance with embodiments of the invention.

FIG. 4 is a block diagram illustrating the financial institution system of FIG. 1, in accordance with embodiments of the invention.

FIG. 5 is a flowchart illustrating the operational steps for processing the transfer of tangible resources, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asset management firms, insurance companies and the like.

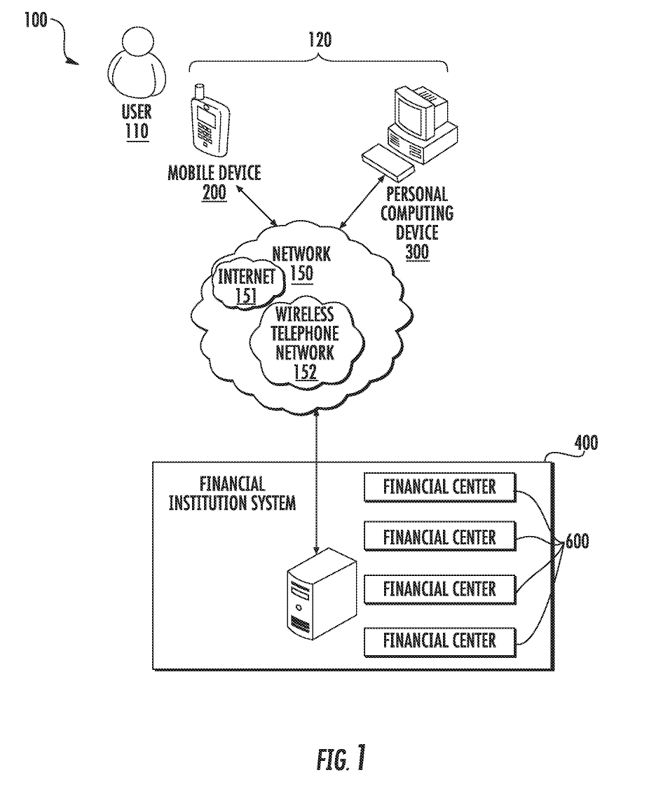

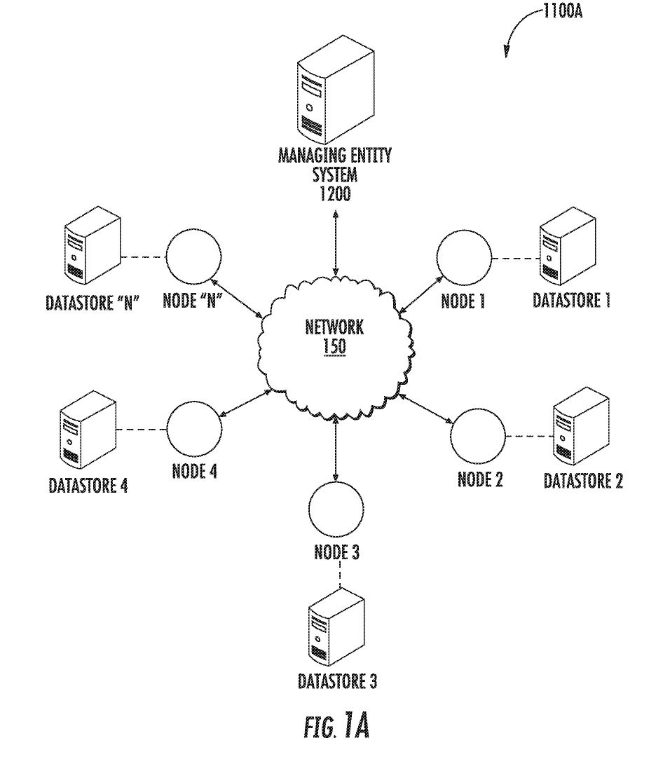

FIG. 1 provides a block diagram illustrating an environment 100 for a system for processing the transfer of tangible resources, in accordance with an embodiment of the invention. As illustrated in FIG. 1, the environment 100 includes a user 110 where the user represents a customer having a relationship with at least one but typically more than one institution. A user of the system may be a person, but may also be a business or any other entity. In a typical environment a great number of users may access the system of the invention. In one embodiment the system for processing the transfer of tangible resources may be the financial system of a financial institution and the resource may be cash. In other embodiments the system for processing the transfer of tangible resources may be a system that processes a tangible asset that cannot ordinarily be processed using an on-line or mobile application.

The environment 100 also may include at least one and in a typical case a plurality of user devices 120 accessible by the user 110. The user devices may comprise any machine, apparatus, system or the like that may be connected to and communicate over network 150. At least one of the user devices may comprise a computing device 120 for use by the user 110. The computing device 120 may be any device that employs a processor and memory and can perform computing functions, such as a personal computing device 300 or a mobile device 200, that may be connected to or access network 150. The personal computing device 300 may comprise a personal computer such as a desk top computer, lap top computer, tablet or any type of personal computing device that may be connected to a network by landline or wireless access such as wireless local area network (WLAN) such as WiFi based on the Institute of Electrical and Electronics Engineers (IEEE) 802.11 standards, Bluetooth short-wavelength UHF radio waves in the ISM band from 2.4 to 2.485 GHz or other wireless access technology. As used herein, the mobile device 200 may comprise any mobile communication device, such as a cellular telecommunications device (i.e., a cell phone or mobile “smart” phone), personal digital assistant (PDA), a mobile Internet accessing device, or other mobile device. A mobile device may connect to the network by a cellular telecommunications network or by WiFi, Bluetooth or other access technology. In some embodiments where, for example, the user 110 is an institution the computing devices 120 may comprise servers, access terminals, or the like.

The computing devices 120 may be configured to communicate over network 150 with at least one entity system such as financial institution system 400 of an entity such as a financial institution. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet 151. In one embodiment, the network 150 may also include a wireless telephone network 152.

In general, the user device 120 is configured to connect with the network 150 and may be used to log the user 110 into the system of the institution that is managing the system for processing the transfer of tangible resources, in the illustrated example the financial institution system 400 of a financial institution. A user 110, in order to access the system, typically uses an online banking application and/or mobile banking application hosted by the financial institution system 400 and must authenticate with the financial institution system 400. For example, logging into the financial institution system 400 generally requires that the user 110 authenticate his/her/its identity using a user name, a passcode, a cookie, a biometric identifier, a private key, a token, and/or another authentication mechanism that is provided by or for the user 110 to the financial institution system 400 via the user device 120. In some embodiments the authentication system may be a tiered system that may require different levels of authentication based on conditions such as, for example, previous activity of the user over the network 150. For example, the tiered authentication system may have three levels of authentication—hard, medium and soft. Hard authentication may require that the user input a high level of authentication information such as a combination of password, user identification, answer to challenge questions, biometrics, random key number or the like. A hard authentication may be required when the user logs on from an unrecognized user device or where the user activity is not recognized by the system. A medium authentication level may require only a user identification and password. A medium level of authentication may be required where, for example, the user has already logged-in to the user device 120 using an authentication procedure for the device such as a thumbprint or password. A soft authentication may require only a user identification such as user name. A soft level of authentication may be used, for example, where the user has already logged-in to the user device 120 using an authentication procedure for the device such as a thumbprint or password and the user has performed activities on the user device that are recognized as “normal” activity for that user and/or the user device is in a recognized location for that user. Thus, the level of authentication required for accessing the banking application, whether online, mobile or in person, may be adjusted based on conditions, activity, functions or information received about or from the user.

In one embodiment, the invention may provide an application download server such that software applications that support the financial institution system 400 can be downloaded to the user devices 120. In some embodiments of the invention, the application download server is configured to be controlled and managed by one or more third-party data providers (not shown in FIG. 1) over the network 150. In other embodiments, the application download server is configured to be controlled and managed over the network 150 by the same entity or entities that maintains the financial institution system 400

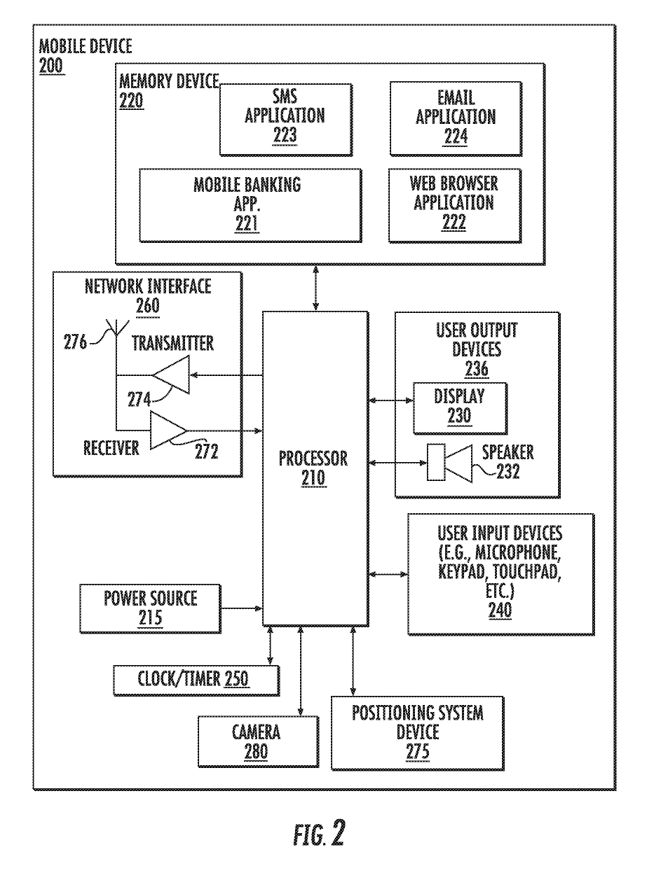

FIG. 2 provides a block diagram illustrating the mobile device 200 of FIG. 1 in more detail, in accordance with embodiments of the invention. In one embodiment of the invention, the mobile device 200 is a mobile telephone. However, it should be understood that a mobile telephone and the embodiment of the mobile device 200 shown in FIG. 2 are merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, tablets, mobile televisions, gaming devices, laptop computers, cameras, video recorders, audio/video player, radio, GPS devices, or any combination of the aforementioned.

Some embodiments of the mobile device 200 include a processor 210 communicably coupled to such devices as a memory device 220, user output devices 236, user input devices 240, and a network interface 260. The mobile device 200 further includes a power source 215, such as a battery, for powering various circuits and other devices that are used to operate the mobile device 200. Embodiments of the mobile device 200 may also include a clock or other timer 250 configured to determine and, in some cases, communicate actual or relative time to the processor 210 or one or more other devices. The mobile device 200 may also include a positioning system device 275 such as a global positioning system (GPS). The processor 210, and other processing devices described herein, generally include circuitry for implementing communication and/or logic functions of the associated device. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory device 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like. The memory device 220 may include other applications such as e-mail app 224 and SMS app 223.

The processor 210 is configured to use the network interface 260 to communicate with one or more other devices on the network 150. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 152. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Consolidated Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 200 may also be configured to operate in accordance with non-cellular communication mechanisms, such as via a wireless local area network (WLAN) or other communication/data networks.

As described above, the mobile device 200 has a user interface that may be made up of user output devices 236 and/or user input devices 240. The user output devices 236 may include a display 230 (e.g., a liquid crystal display or the like) and a speaker 232 or other audio device, which are operatively coupled to the processor 210. The user input devices 240, which allow the mobile device 200 to transmit data, may include any of a number of devices allowing the mobile device 200 to transmit data, such as a keypad, keyboard, touch-screen, touchpad, microphone, mouse, joystick, other pointer device, button, soft key, and/or other input device(s).

The mobile device may also include a camera 280. The camera may function to take pictures and store the images in memory device 220. The stored images may be transmitted by the mobile device 200 via network interface 260 over network 150 to the third party institution system 400.

The memory device 220 is operatively coupled to the processor 210. The memory device 220 can store any of a number of applications which comprise computer-executable instructions/code executed by the processor 210 to implement the functions of the mobile device 200 and/or one or more of the process/method steps described herein. The memory device 220 also includes a mobile banking application 221 that may be used to allow communication with a system such as the financial institution system 400 to implement the system of the invention. The mobile banking application 221 may include an interface or tangible resource transfer processing application that enables communication with the tangible resource transfer processing application 500 on the financial institution system 400. The use of the mobile banking application 221 may facilitate access to the system of the invention by providing log-in systems including user authentication systems, account information, system controls or the like. The mobile banking application 221 also allows communication to the financial institution to allow the user to set up and/or control the system of the invention.

These applications also typically provide a graphical user interface (GUI) on the display 230 that allows the user 110 to communicate with the mobile device 200, the financial institution system 400 and/or other devices or systems. The memory device 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory device 220 may include such data as user authentication information.

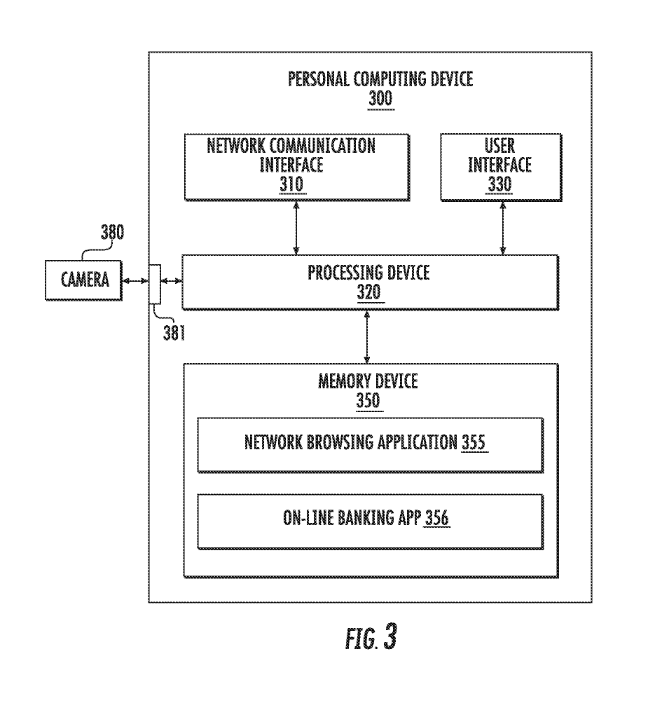

Referring now to FIG. 3, the personal computing device 300 also includes various features, such as a network communication interface 310, a processing device 320, a user interface 330, and a memory device 350. The network communication interface 310 includes a device that allows the personal computing device 300 to communicate over the network 150. In one embodiment of the invention, a network browsing application 355 provides for a user to establish network communication with a financial institution system 400. The memory device 350 may include such applications as the conventional web browser application 355 and/or an on-line banking application 356. The on-line banking application 356 may be used to allow communication with the entity system such as financial institution system 400 to provide access to the financial institution system providing log-in systems including user authentication systems, account information or the like as previously described with respect to FIG. 2. The on-line banking application 356 also allows communication to the financial institution system 400 to allow the user to set up and/or control the system of the invention. The on-line banking application 356 may include an interface or tangible resource transfer processing application that enables communication with the tangible resource transfer processing application 500 on the financial institution system 400.

The personal computing device may also include a camera 380. The camera may function to take pictures and store the images in memory device 350. The stored images may be transmitted by the personal computing device 300 via network interface 310 over network 150 to the third party institution system 400. The camera may be part of the personal computing device or it may comprise a peripheral device that may be operatively connected to the personal computing device at an interface 381 such as a USB port to transmit signals and data between the personal computing device and the camera 380.

As used herein, a “processor” or “processing device,” such as the processing device 320, processing device 420 and processor 210, generally refers to a device or combination of devices having circuitry used for implementing the communication and/or logic functions of a particular system. For example, a processing device or processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device or processor may further include functionality to operate one or more software programs based on computer-executable program code thereof, which may be stored in memory device. As the phrase is used herein, a processor or processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” generally includes a plurality of user input and output devices and/or software that allow a customer to input commands and data to direct the processing device to execute instructions and to receive communications from the computing devices 120. For example, the user interface 330 presented in FIG. 3 may include a graphical user interface (GUI) or an interface to input computer-executable instructions that direct the processing device 320 to carry out specific functions and an output to communicate with the user 110. The user interface 330 employs certain user input and user output devices as previously described with reference to FIGS. 1 and 2. These input and output devices may include a display, mouse, keyboard, button, touchpad, touch screen, microphone, speaker, LED, light, joystick, switch, buzzer, bell, and/or other user input/output device for communicating with one or more users.

As used herein, a “memory” or “memory device” generally refers to a device or combination of devices that store one or more forms of computer-readable media for storing data and/or computer-executable program code/instructions. Computer-readable media is defined in greater detail below. For example, in one embodiment, the memory devices described herein include any computer memory that provides an actual or virtual space to temporarily or permanently store data and/or commands provided to the processing device when the processing device carries out its functions described herein. As used herein, “memory” or “memory device” includes any computer readable medium (as defined herein below) configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like.

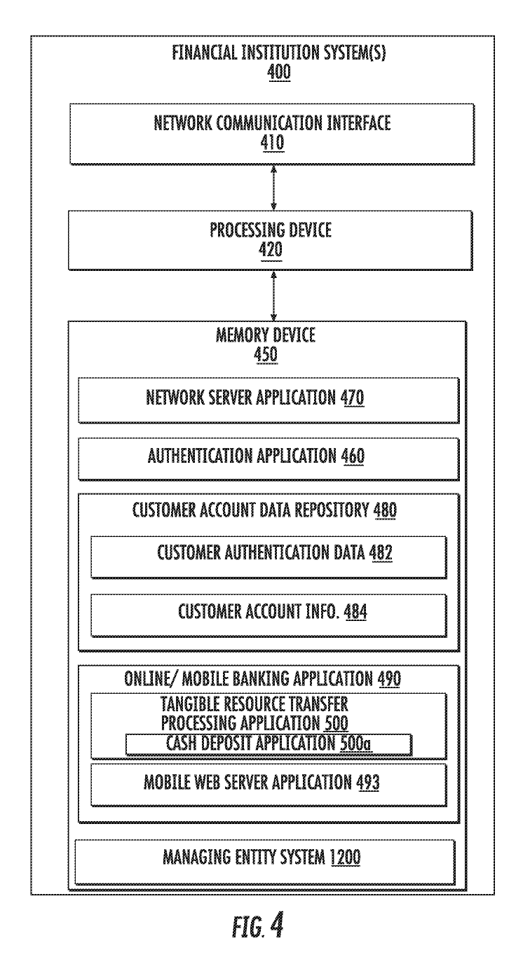

FIG. 4 provides a block diagram illustrating the third party institution system such as financial institution system 400, in greater detail, in accordance with embodiments of the invention. As illustrated in FIG. 4, in one embodiment of the invention, the financial institution system 400 includes one or more processing devices 420 operatively coupled to one or more network communication interfaces 410 and one or more memory devices 450. In certain embodiments, the financial institution system 400 is operated by an entity, such as a financial institution.

It should be understood that the memory device 450 may include one or more databases or other data structures/repositories. The memory device 450 also includes computer-executable program code that instructs the processing device 420 to operate the network communication interface 410 to perform certain communication functions of the financial institution system 400 described herein. For example, in one embodiment of the financial institution system 400, the memory device 450 includes, but is not limited to, a network server application 470, an authentication application 460, a customer account data repository 480 which includes customer authentication data 482 and customer account information 484, an on-line/mobile banking application 490 comprising a mobile web server application 493, and other computer-executable instructions or other data such as resource applications for executing transactions with the financial institution. The computer-executable program code of the network server application 470, the authentication application 460, or the on-line/mobile banking application 490 may instruct the processing device 420 to perform certain logic, data-processing, and data-storing functions of the financial institution system(s) 400 described herein, as well as communication functions of the financial institution system(s) 400. The mobile banking application 490 communicates with the user computing devices 120 to facilitate communication between the user and the financial institution.

In one embodiment, the customer account data repository 480 includes customer authentication data 482 and customer account information 484. The network server application 470, the authentication application 460, and the mobile banking application 490 are configured to invoke or use the customer account information 484, the customer authentication data 482 when authenticating a user to the financial institution system(s) 400. The financial institution system 400 further includes a tangible resource transfer processing application 500 that communicates with the user device 120 as will be described. In the embodiment of a financial institution as shown in FIG. 4 the tangible asset may be cash or other negotiable instrument. The tangible resource transfer processing application 500 may be a cash deposit application that functions to process cash deposits initiated from user devices 120 as will be described.

As used herein, a “communication interface” generally includes a modem, server, transceiver, and/or other device for communicating with other devices on a network. The network communication interface 410 is a communication interface having one or more communication devices configured to communicate with one or more other devices on the network 150, such as the mobile device 200, and/or the personal computing device 300. The processing device 420 is configured to use the network communication interface 410 to transmit and/or receive data and/or commands to and/or from the other devices connected to the network 150.

The environment may also comprise at least one financial center 600, FIG. 1, that is related to and may form part of the financial institution system that operates and controls the financial institution system 400. The financial center(s) 600 may be a branch office, an ATM machine or other type of facility that may provide in-person customer service and support for the financial institution. The financial centers 600 may also include centralized facilities that are accessible by the distributed financial centers. Typically, the financial institution system 400 comprises a plurality of financial centers that are geographically dispersed to provide services to the financial institution's customers over a wide, and potentially international, geographic area. The financial centers 600 may include at least portions of the financial institution systems 400 that allow each financial center 600 to communicate with other elements of the financial institution system 400 and the user devices 120 over network 150. Each financial center 600 may have access to all or a portion of the financial institution system(s) 400 such that each financial center 600 can communicate with and access at least portions of the processing device 420 and memory device 450 of the financial institution system and in some embodiments the various local systems of the financial centers 600 may be considered to be part of a distributed financial institution system 400. Thus, while the financial centers 600 may be geographically distributed, the financial centers 600 may be considered to form part of the financial institution system(s) 400 as previously described. Each financial center 600 typically includes local processing devices 420 and memory devices 450 and network interface devices 410 that allow the local system of the financial centers 600 to communicate over the network 150 with one another and with centralized systems of the financial institution. The financial centers 600 may also comprise a local customer account data repository, a local online/mobile banking application, a local tangible resource transfer processing application to facilitate communication, data management and security among the financial centers.

In a typical relationship the user 110 is a customer of the financial institution, or other institution, that operates financial institution system 400, or other third party institution system, and engages the financial institution for a variety of services and products. The user may have relationships with more than one institution and the relationship between each user and an institution may be different where different products and services are provided by the institution and/or utilized by the user. In a typical relationship the user 110 may be able to utilize on-line/mobile applications of the institution that can be accessed through user device 120 to obtain services and products offered by the institution system and to complete financial transactions and/or other transactions with and/or through the institution. Moreover, at least some of the services and products that are available through the on-line/mobile applications are also available as physical transactions.

In some embodiments the system of the invention may form part of or be associated with a resource tracking system. An embodiment of a resource tracking system is shown in FIG. 1A. The tracking network 1100 comprises a plurality of nodes (e.g. Node 1 through Node N) that may comprise or otherwise be in communication with one or more node datastores (e.g., Datastore 1, Datastore 2, Datastore 3, Datastore 4, through Datastore “N”). While FIG. 1A illustrates one datastore for each node, it should be known that each node may be associated with one or more datastores, and a single datastore may be associated with more than one node. For example, the managing entity system 1200 may comprise a master datastore, such that information from each node may be transmitted to the managing entity system 1200 and stored in the master datastore within the managing entity system. In such embodiments, nodal information may not be stored in datastores associated with each node. In some embodiments, nodal information for one node may be stored in multiple datastores within the system, thereby backing up the nodal information on separate datastores for security and validation purposes. The managing entity system 1200 may be part of the financial institution system 400 as shown in FIG. 4, it may be a network of such systems that are operatively connected to one another, or it may be a separate system that is capable of communicating with the financial institution system 400.

As described above, a node generally refers to a physical electronic device that is in network communication with one or more other nodes and/or a managing system. In a financial system such as shown and described with respect to FIG. 1, examples of the electronic device comprising the node includes, but is not limited to, automated teller machines (ATMs), financial center systems (e.g., ATMs, point of sale (POS) devices, scanning devices, electronic safety deposit devices, and the like), merchant systems (e.g., cash registers, vending machines, self-checkout devices, POS devices, electronic safes, scanning devices, and the like), delivery vehicle systems (e.g., mobile resource monitoring devices, and the like), mobile devices (e.g., mobile smart phones, mobile scanning devices, and the like), and/or cash inventories such as vaults. Of course, any other device or system can be considered a node, as long as it is configured to acquire, store, and/or transmit information to the managing entity system 1200 and/or other nodes within the network 1100A. The nodes of FIG. 1A may comprise or form a part of the financial centers 600 as shown and described in FIG. 1. Each financial center may also comprise more than one node.

Additionally or alternatively, a node may refer to a physical location (e.g., a geographic location, a geographic region, a store or other building location, a non-electronic location like a safe, and the like). In such embodiments, one or more datastores may be associated with the physical locations, such that at least a portion of each datastore comprises information that is associated with contents of the physical location. For example, a datastore associated with a mobile scanning device used by a delivery vehicle driver may be associated with contents of an associated delivery vehicle, such that the datastore comprises information (e.g., real-time information and/or historical information) about contents of the delivery vehicle.

In some embodiments, the nodes (or electronic devices associated with the nodes), may be configured to track movement of tangible resources (e.g., cash, bank notes, valuable items, and the like) throughout the network 1100A. In some such embodiments, the nodes are configured to track individual bills, bank notes, and the like, across the network 1100A to determine quantities and values of cash at each node at one or more points in time. By tracking the quantities and values of cash at each node in the network 1100A over time (e.g., continuously in real-time, in near real-time, or periodically), a system can identify trends of the movement of cash throughout the network 1100A.

Therefore, in some embodiments, individual cash bills (e.g., bank notes) are analyzed (e.g., as they are received, while they are stored, and/or as they are being dispensed or are otherwise leaving) at a node of the network 1100A. For example, a bank note deposited at a node comprising a financial center may be scanned by a scanner of the financial center to ascertain identifiable information of the bank note.

The term identifiable information, as used herein, shall refer to any information that may be ascertained from a bank note to identify one or more of the following features: a bank note denomination, a coin denomination, a serial number, a date of printing or manufacture, a location of printing or manufacture, a weight, a metallic content, an ink type, a paper type, a security measure (e.g., a reflective characteristic, a watermark, and the like), a marking (e.g., an intentional marking or a general wear and tear marking), an imbedded RFID tag or other electronic tracking device, physical characteristics of the bank note, or any other information that identifies the bank note in some way and/or provides information about the authenticity of the bank note. The term identifiable information may also comprise other information used to identify tangible resources such as VIN (vehicle identification number) to identify a vehicle, a stock certificate serial number, or the like.

Any type of scanner may be used at a node, including scanners designed specifically to measure or otherwise ascertain one or more piece of identifiable information. For example, a scanner may be an optical camera, an infrared camera, a barcode scanner, a quick response (QR) code scanner, a radio frequency identification (RFID) tag scanner, a scale, an optical character recognition (OCR) device, a smartphone (or a component of a smartphone), and the like. Additionally or alternatively, identifiable information of one or more bank notes may be manually input into a node database by a user, merchant, employee of a financial institution, employee of a managing entity, and the like. For example, a user may manually input a denomination and serial number of a bank note before storing the bank note in an electronic safe.

The datastores (e.g., Datastore 1, Datastore 2, Datastore 3, Datastore 4, through Datastore “N”), may record the identifiable information for one or more bank notes associated with their respective nodes (Node 1, Node 2, Node 3, Node 4, through Node “N”, respectively). In this way, the network 1100A can maintain a real-time, near real-time, and/or periodic point-in-time picture of the contents of each individual node in the network 1100A and the contents of the network 1100A as a whole. To accomplish the task of maintaining a survey of the node contents (and the network 1100A as a whole), each datastore within the network 1100A may record information that will enable the managing entity system 1200 to monitor the node contents. Therefore, each datastore in the network 1100A may store information associated with the denominations of bank notes located at its respective node, serial numbers (or other unique identifiers) of bank notes at its respective node, validity information (e.g., information associated with the confidence that the received or stored bank note is an authentic bank note), quality information (e.g., information associated with the structure, visibility, age, and the like of received or stored bank notes), and the like. In some embodiments, one or more datastores may provide a breakdown of bank notes that are associated with one or more nodes, one or more customers, and the like. For example, a node comprising a financial center system may associate each received bank note with one or more checking accounts, savings accounts, investing accounts, and the like for one or more customers of financial center system. In this way, the datastore of the financial center system node can store information about the total cash situation for the financial center system as well as information about sub-categories (e.g., users, accounts, and the like) within the financial center system. Furthermore, datastores associated with each node may store timing information about each received or scanned bank note to identify time of receiving or dispensing of the bank note.

In this way, the managing entity system 1200 of the network 1100A may be configured to monitor the identifiable information stored at each node to determine characteristics of the network 1100A. For example, the managing entity system 1200 can determine a total value of the bank notes accounted for in the network (e.g., located at each node, in transit between nodes, a cumulative total value for all nodes, and the like). The managing system 1200 can also track one or more single bank notes (e.g., by tracking a serial number or other unique identifier of the single bank note) over time as the one or more bank notes progress through the network 1100A.

By tracking individual bank notes through multiple nodes of the network 1100A, the managing entity system 1200 may be able to identify trends of the network as a whole as well as trends of each individual node. For example, the managing entity system 1200 may be able to make determinations about when a node is likely to run low on cash. To illustrate this example, we can assume Node 1 is an ATM that is configured to accept deposits of cash and to dispense cash as customers of the managing entity desire. The managing entity system 1200 may track a quantity of each denomination of bank note stored within a cash receptacle of Node 1, and/or a total value of the bank notes stored at the ATM of Node 1 over a period of time. Once the tracking of the quantity of each denomination of bank notes and/or the total value of bank notes stored at Node 1 dips below one or more predetermined threshold values, the managing entity system 1200 may automatically transmit an alert or instructions to a delivery vehicle system or other system of the managing entity system 1200 to provide additional bank notes (and, in some embodiments, a specific quantity of one or more bank notes and/or a specific total value of bank notes) to the ATM of Node 1 within a defined period of time to prevent the ATM from running out of available funds for withdrawal.

In some such embodiments, the managing entity system 1200 may determine, based on tracking the identifiable information of bank notes stored at Node 1, a trend in the quantity of one or more denominations of bank notes and/or a total value of the bank notes stored at Node 1. In this way, the managing entity system 1200 may extrapolate the trend to identify a point in time that the ATM of Node 1 should be refilled with new bank notes, as described above. By determining a trend of the bank note denomination quantity (or quantities) and/or the total value of Node 1, the managing entity system 1200 can transmit instructions for refilling the ATM of Node 1 at a later point in time, to provide more time for a refilling system (e.g., a delivery driver and a delivery vehicle) to prepare for refilling, and to travel to the physical location of the ATM of Node 1. In this way, the managing entity system 1200 can organize or adjust a delivery system schedule ahead of time, before a node runs low on available funds for dispensing.

The identifiable information of contents at a node can be tracked and/or associated with time of day, time of month, day of the week, holiday, and other calendar-based scenarios to predict how the amount of cash located at each node (as well as how much cash is transported between two or more nodes) can be expected to change at any given time. For example, the managing entity system 1200 determine, based on historical data for each node, that financial center nodes of the network 1100A tend to incur a significant decrease in the total amount of cash available near the end of each work week. As such, the managing entity system 1200 can use the historical data of each financial center node to predict how much cash is expected to be dispensed at each respective node and thereby can plan to provide at least the respective predicted amount of cash for each node ahead of time.

The managing entity system 1200 can also monitor the network 1100A to identify inconsistencies, duplicate items, and other potential issues with one or more nodes in the network 1100A. For example, the managing entity system 1200 may determine that multiple nodes have identified a duplicate serial number for a bank note (i.e., a first node reports that a bank note with a specific serial number is securely stored in the physical location of the first node and a second node reports that a bank note with the same specific serial number is stored in the physical location of that second node.) This determination of multiple bank notes comprising the same serial number (or other unique identifying information) may inform the managing entity system 1200 of a potential error, a potential malfeasance, or some other issue that should be addressed. In some embodiments, the managing entity system 1200 may be configured to transmit one or more instructions (e.g., a command signal or other electronic signal) to an electronic device associated with one or more of the affected nodes in the network 1100A, where the instructions are configured to cause the electronic device to shut down, change security protocols (e.g., require an additional level of authorization before withdrawal of cash, and the like), physically separate bank notes with duplicate serial numbers (e.g., place bank notes with a duplicate serial number somewhere in the network 1100A in a separate compartment that is not part of dispensing activities of the node), and the like.

In some embodiments, the managing entity system 1200 may track individual bank notes and is thereby able to identify potential cash purchases and other spending made by customers at a merchant node within the network 1100A. For example, a managing entity 1200 may track a bank note at an ATM node by scanning the bank note for a serial number, determine that this specific bank note is withdrawn from the ATM node by a known customer, and at a later point in time identify the same bank note (i.e., by scanning the bank note to identify the same serial number) at a self-checkout device of a merchant node within the network 1100A. The implication here is that the same user has conducted the cash transaction at a merchant store associated with the merchant node. Therefore, the managing entity system 1200 may transmit an alert to the known customer (e.g., via a mobile device known to be associated with the known merchant, or the like), where the alert requests confirmation of the customer's purchase at the merchant node.

By tracking the cash flow from an ATM node to a merchant node within the network 100A, the managing entity can update information associated with the known customer's online banking data to include information associated with information received from the merchant node. For example, the merchant node may transmit product information, price information, merchant type information, time of transaction information, and the like to the managing entity system 1200, and the managing entity system 1200 may update historical transactional information of the known customer. This technique of tracking cash purchases enables a financial institution to provide a more robust account of the known customer's transactions over time than by using credit, debit, and online transactional information alone.

The tracking of resource flow through a system such as cash flow through a monetary system allows the system to utilize the resource based on the flow of the resource through the system rather than or in addition to tracking the resource at the transaction level. Thus the system operator may process and/or complete transactions based on known characteristics of the resource in the system.

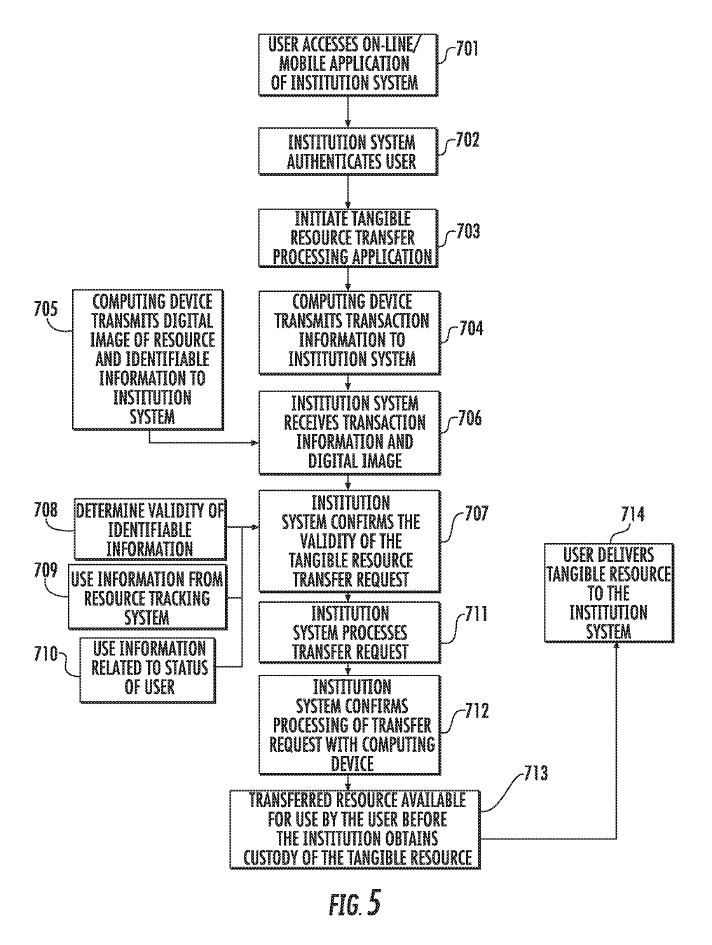

An embodiment of a system for processing tangible resource transfers will be described with reference to FIG. 5. The embodiment shown in FIG. 5 will be more specifically described as it relates to a cash deposit transaction with a financial institution system; however, the system of FIG. 5 may be used to process other tangible resource transfers with the financial institution or with other types of third party institutions. In a cash deposit transaction the tangible resource is cash or bank notes, the system is financial institution system 400, the transaction is a deposit of the cash and the user is a customer of the financial institution that wants to make a deposit of cash into an account using an on-line or mobile banking application. The cash deposit may be immediately processed by the financial institution, for example, to make a payment to another entity as directed by the user without the institution system having obtained physical custody of the tangible resource. Allowing a user to deposit cash or other tangible asset using an on-line or mobile application allows the system (e.g. the financial institution) to process the resource (e.g. credit the cash deposit to a user account) without the system having the physical custody of the resource at the time of processing of the transaction. The user is then obligated by the terms of service with the system institution (e.g. the financial institution) to deposit or otherwise provide the identified resource to the institution system (e.g. deposit the cash with the financial institution via a physical deposit at a financial center such as a branch office, ATM or the like). While the invention is described where the resource is cash and the system processes the resource to deposit the resource with a financial institution, the resource may comprise any tangible resource and the system may operate to perform other functions than to deposit the resource with a financial institution. For example, the resource may comprise any identifiable tangible resource of value such as coins, precious metals, contracts, certificates of deposit, stocks certificates, vehicles (such as automobiles, boats, airplanes, trucks or the like), the institution system may comprise any institution system (such as an automobile dealership, on-line store, on-line real property web site or the like) and the transaction may be any transaction that utilizes the resource (such as a vehicle trade-in, stock redemption, deposit of earnest money or the like).

Referring again to FIG. 5, in the illustrated embodiment of the system of the invention a user accesses an online/mobile banking application 490 of an third party institution system such as a financial institution system 400 from the computing device 120 such as mobile device 200 using the mobile banking application 221 or from personal computing device 300 using the on-line banking application 356 and utilizing the application (Block 701). The online/mobile banking application 490 of the financial institution system 400 authenticates the identity of the user (Block 702). The tangible resource transfer processing application 500 is initiated based on a request received from the tangible resource transfer processing application on the computing device 120 (Block 703). A message is sent from user device 120 via network 150 that is received by the financial institution system. Upon receipt of the message the financial institution system 400 initiates the functionality of the tangible resource transfer processing application 500. In one example, in the case of a financial institution system 400 the tangible resource transfer processing application 500 may comprise a cash deposit application 500a that may be initiated based on the request received from computing device 120. In the embodiment of a cash deposit, the cash deposit application functions to deposit cash with the financial institution system 400 using the computing device 120 without the financial institution system obtaining physical custody of the tangible asset at the time of the deposit. After logging into and being authenticated by the system 400 the user may be required to enter identification information such as name, mobile phone number or e-mail address. The user is also required to enter transaction specific information such as the dollar amount of the cash deposit and the account information (e.g. the account number) of the account to which the deposit is to be made. The user computing device 120 transmits the transaction information to the financial institution system (Block 704). In addition to transmitting the identification information as set forth above, the user also transmits a digital image of the cash or other resource that is to be deposited or otherwise transferred to the financial institution system 400 (Block 705). The transmitted image may include identifiable information of the specific cash, or other resource, that forms the basis of the deposit or other transfer. For example, the image may include the serial number of the cash or bank notes to be deposited. In other embodiments cash may be printed with other identifying marks by the United States mint when the cash is printed. In other embodiments, the image may comprise an image of the resource and identifiable information such as an identification of a vehicle and vehicle identification Number (VIN), an image of a stock certificate or the like. The financial institution system receives the transaction information and the digital image transmitted by the user computing device 120 (Block 706). The terms of service with the financial institution may require that the same resource (e.g. cash) identified in the transmitted image be deposited with the financial institution and not merely a resource of the same value. In such an embodiment the user may not be permitted to deposit another bank note in place of the bank note identified in the transmitted image. Such a requirement, in addition to providing proof that the transaction has been completed by the user also allows the financial institution to track and monitor the flow of currency through the system as previously described.

The financial institution system 400 confirms the validity of the tangible resource transfer request, which in the present embodiment is a request for cash deposit (Block 707). For example, the system may confirm that the identification information such as serial number is valid, is not a duplicate of a known resource, is registered to the user or the like (Block 708). Moreover, because the resource transaction described herein may form part of a larger resource tracking system as described with respect to FIG. 1A, the system such as the financial institution system 600 may be in possession of information that may be used to confirm the validity of the transaction in addition to the image provided by the user. For example, the tracking of the cash through the network 1100A may confirm that the cash deposited by the user was in circulation in geographic and/or time proximity to the user or it may be used to confirm that the cash was transferred to the user at another node in the system, or that the cash identified in the image is not a duplicate of cash identified elsewhere in the monetary system (Block 709). In some embodiments the system may rely only on the image transmitted with the request. In some embodiments, utilization of the system may be limited to preferred users that have an established relationship with the financial system where access to the system requires preapproval, registration and or qualification (Block 710). For example, in addition to confirming the identity of the user, the financial institution may also require that the user have a minimum balance, enroll in a higher level of service with the financial institution or otherwise have a predefined relationship with the financial institution.

After confirming the validity of the request, the financial institution processes the tangible resource transfer request (i.e. the cash deposit request) by, for example, crediting the cash deposit to the designated account of the user (Block 711). After the cash deposit is completed, the financial system 400 may transmit an e-mail or text message to the computing device 120 of the user that confirms the deposit (Block 712). The transferred resource may then be immediately used by or made available to the user before the institution system obtains physical custody of the tangible resource (Block 713). The financial institution system may allow the user to make use of the deposited cash immediately without having actual physical custody of the physical cash. For example, the user may instruct the financial institution, via the mobile banking application 221 or on-line banking application 356, to make a payment, make a person to person payment, or the like using the transferred resource immediately upon completion of the transfer request.

Under the terms of agreement between the institution and the user, the user must deliver physical custody of the tangible asset to the institution by a predetermined time and in a predetermine manner (Block 714). For example, the user may be required to make a physical deposit of the bank note at a financial center within 24 hours of the completion of the tangible resource transfer request.

Another example embodiment of a tangible resource transfer is where the tangible resource is a used automobile that is to be transferred to an automobile dealership as a trade-in as part of a transaction for the purchase of a new automobile. The trade-in, as well as the new car purchase, may be initiated from the computing device 120 using the mobile application 221 or using the on-line application 356 with an automobile dealership institution system (Block 701). The online/mobile application of the automobile dealership institution system authenticates the identity of the user (Block 702). The tangible resource transfer processing application 500 is initiated based on a transfer request received from the computing device 120 (Block 703). After logging into the secure system the user transmits transaction information such as name, mobile phone number or e-mail address, the VIN number of the used automobile trade-in and the purchase information for the new automobile. (Block 704). In addition to transmitting the transaction information as set forth above, the user also transmits a digital image of the trade-in including an image of the vehicle identification information number or VIN of the vehicle that is to be traded in to the dealership (Block 705). The dealership institution system receives the new car purchase request and the trade-in information and the associated images (Block 706). The institution system 400 confirms the validity of the trade-in request (Block 707) using validation information related to the user, the identifiable information and/or the resource tracking system (Blocks 708-710). For example the dealership may require a relationship with the purchaser such as a fleet purchaser with whom the dealership has a prior relationship (Block 710), the dealership may confirm ownership of the vehicle using a resource tracking system (Block 709), or the dealership may confirm the validity of the VIN as it relates to the identified vehicle (Block 708). After confirming the validity of the request, the financial institution credits the trade-in value to the purchase price of the new automobile (Block 711). After the transaction is completed, the financial system 400 may transmit an e-mail or text message to the user device 120 that confirms the transaction (Block 712). The dealership may credit the value of the trade-in immediately without having actual physical custody of the trade-in vehicle (Block 713) and apply the trade-in value to the new car purchase. The user is then obligated to provide the trade-in vehicle to the dealership within an agreed upon period of time (Block 714). The terms of service with the dealership may require that the same resource, the automobile identified in the transmitted image, be delivered to the institution (e.g. the automobile dealership) by a certain date or within a certain time period.

In some embodiments, the tangible resource transfer processing application 500 may transmit a message to the user device 120 that provides the telephone number or other contact information for a local financial center 600, and/or directions to the nearest, or a user selected, financial center(s). To select the designated financial center 600 for a particular user the tangible resource transfer processing application 500 may use the location information provided by the positioning system device 275 on user's mobile device 200. For a personal computing device 300 the contact information may for the financial center closest to the user's home or work place or the user's most visited financial center. In other embodiments the user may manually select a desired financial center to complete the transaction and deliver the tangible resource to the institution.

The tangible resource transfer processing application 500 may also be used to set up further interactions between the third party institution and the user. In one embodiment transaction information relating to the transaction is transmitted from the financial institution system 400 to the designated financial center 600 and/or to the user computing device 120. For example, the application may schedule an appointment for the user at a designated financial center to complete the transaction and may transmit documents or instructions or other information to that financial center that is used by the financial center to complete the transaction with the user. The tangible resource transfer processing application 500 may also transmit a code or other information to the user device 120 that may be used by the user to at the financial center to identify the transaction and validate the user's identity.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium. Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s).

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein. As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium. Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s).

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

To supplement the present disclosure, this application further incorporates entirely by reference the following commonly assigned patent applications:

| | U.S. patent application | | |
|---|---|---|---|
| Docket Number | Ser. No. | Title | Filed On |
| 7637US1.014033.2980 | To be assigned | RESOURCE GRID SYSTEM | Concurrently |
| | | FOR TRACKING AND | herewith |
| | | RECONCILING RESOURCE | |
| | | MOVEMENT | |
| 7639US1.014033.2975 | To be assigned | SYSTEM FOR | Concurrently |
| | | GENERATING AND | herewith |
| | | PROVIDING SEALED | |
| | | CONTAINERS OF | |
| | | TRACEABLE RESOURCES | |
| 7640US1.014033.2979 | To be assigned | SYSTEM FOR PROCESSING | Concurrently |
| | | RESOURCE DEPOSITS | herewith |
| 7736US1.014033.3017 | To be assigned | SYSTEM FOR PROVIDING | Concurrently |
| | | ON-DEMAND RESOURCE | herewith |
| | | DELIVERY TO RESOURCE | |
| | | DISPENSERS | |
| 7785US1.014033.3015 | To be assigned | SYSTEM FOR PROVIDING | Concurrently |
| | | REAL-TIME TRACKING OF | herewith |
| | | INDIVIDUAL RESOURCE | |
| | | ITEMS TO IDENTIFY | |
| | | SPECIFIC RESOURCE | |
| | | TRANSFERS | |
| 7796US1.014033.3018 | To be assigned | SYSTEM FOR PROVIDING | Concurrently |
| | | REAL-TIME TRACKING OF | herewith |
| | | INDIVIDUAL RESOURCE | |
| | | ITEMS TO IDENTIFY | |
| | | UNAUTHORIZED | |
| | | RESOURCE TRANSFERS | |

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed:

1. A system for processing a tangible resource, the system comprising:
a network communication interface;
a memory device storing a tangible resource transfer processing application; and
a processing device operatively coupled to the memory device, wherein the processing device is configured to execute computer-readable program code to:
receive a request to process a tangible resource from a user;
receive an image including identifiable information of the tangible resource;
determine a validity of the request; and
upon determination that the request is valid, process the tangible resource without having physical custody of the tangible resource.

2. The system of claim 1, wherein the tangible resource comprises cash.

3. The system of claim 2, wherein the identifiable information comprises a serial number of the cash.

4. The system of claim 2, wherein the image comprises an image of the cash.

5. The system of claim 2, wherein the one or more processing devices are further configured to execute computer-readable program code to deposit the cash with a financial institution.

6. The system of claim 1, wherein the request to process the tangible resource is received from at least one of a mobile device and a personal computing device.

7. The system of claim 1, wherein the one or more processing devices are further configured to execute computer-readable program code to receive physical custody of the tangible resource after processing the tangible resource.

8. The system of claim 1, wherein the validity of the request is determined using input from a resource tracking system.

9. The system of claim 1, wherein the validity of the request is determined using a status of the user.

10. The system of claim 1, further comprising transmitting a confirmation to the user after completing processing the request.

11. A computer implemented method for processing a tangible resource, the method comprising:
receiving a request to process of a tangible resource from a user;
receiving an image including identifiable information of the tangible resource;
determining a validity of the request; and
upon determining that the request is valid, processing the tangible resource without having physical custody of the tangible resource.

12. The computer implemented method of claim 11, wherein the tangible resource comprises cash.

13. The computer implemented method of claim 12, wherein the identifiable information comprises a serial number of the cash.

14. The computer implemented method of claim 12, wherein the image comprises an image of the cash.

15. The computer implemented method of claim 12, further comprising depositing the cash with a financial institution.

16. The computer implemented method of claim 11, further comprising receiving physical custody of the tangible resource after processing the tangible resource.

17. The computer implemented method of claim 11, wherein determining the validity of the request comprises using input from a resource tracking system.

18. The computer implemented method of claim 11, wherein determining the validity of the request comprises using a status of the user.

19. A computer program product for processing a tangible resource, the computer program product comprising at least one non-transitory computer readable medium comprising computer readable instructions, the instructions comprising instructions for:
receiving a request to process of a tangible resource from a user;
receiving an image including identifiable information of the tangible resource;
determining a validity of the request; and
upon determining that the request is valid, processing the tangible resource without having physical custody of the tangible resource.

20. The computer program product of claim 19, wherein the image comprises an image of the cash.
